(19) United States
(12) Patent Application Publication
(10) Pub. No.: US 2019/0101024 A1
(43) Pub. Date: Apr. 4, 2019

(54) ASSEMBLY PROVIDED WITH A ROTATING SUPPORTING MEMBER AND WITH AN OIL TRANSFER UNIT FOR TRANSFERRING OIL TO SUCH ROTATING SUPPORTING MEMBER

(71) Applicant: GE AVIO S.R.L, Rivalta di Torino (IT)

(72) Inventor: Michele Gravina, Minervino Murge (IT)

(21) Appl. No.: 16/094,892

(22) PCT Filed: Apr. 19, 2017
(86) PCT No.: PCT/EP2017/059308

§ 371 Date: Oct. 19, 2018

(30) Foreign Application Priority Data
Apr. 20, 2016 (IT) 102016000040586

(51) Int. Cl. F01D 25/18; F01D 25/16; F02C 7/36

(52) U.S. Cl. CPC F01D 25/18; F16C 33/6659; F02C 7/36; F01D 25/16

(57) ABSTRACT

An assembly has a supporting element, rotatable about an axis, and an oil transfer unit, which has a stationary part and a rotating part, coupled in an angularly fixed position to the supporting member and defining an inner chamber permanently communicating with an oil mouth of the stationary part; the unit 1 further has a floating part, that is fitted onto an outer cylindrical surface of the rotating part and is coupled to the stationary part in an angularly fixed position and with a defined freedom of movement; the assembly further has a connection member coaxial to the rotating part and the supporting element 4 and including a first portion fixed to the rotating part, a second portion fixed to the supporting element and an intermediate portion, which is elastically flexible.

### BACKGROUND

The present invention relates to an assembly provided with a rotating supporting member and with an oil transfer unit, for transferring oil from a stationary part to such rotating supporting member. In particular, the following description will refer to a supporting member defined by a rotating planet carrier of an epicyclic transmission in a turbine engine, but without losing in generality because of this explicit reference.

As is known, an epicyclic transmission comprises a sun gear, a ring gear and a plurality of planet gears, which are located between the sun gear and the ring gear and are supported by a carrier. A transmission of such a type is capable of transmitting the motion between coaxial shafts rotating at different speeds, and is very effective in providing such a function while maintaining small weight and volumes. Epicyclic transmissions are widely used in aeronautical turbine engines, to drive a fan (in so-called turbo-fan engines) or a propeller (in so-called turbo-propeller engines).

In most applications, the carrier is of static type and is coupled to a fixed frame of the engine by a flexible element. Under these conditions, the components supported by the carrier (the planet gears, possible rolling bearings, etc.) are lubricated without particular difficulty via ducts which are fixed with respect to the engine frame and to the carrier.

On the other hand, certain applications employ a rotating carrier, by way of example when the carrier is connected to a rotating driven shaft or when there is a need to continuously control the speed ratio between the sun gear and the ring gear or, alternatively, between the carrier and the ring gear. In particular, the configuration of the epicyclic transmission is called “planetary” when the ring gear is stationary and the carrier is rotating, and “differential” when all three elements, i.e. sun gear, ring gear and carrier, are rotating.

In these cases, an oil transfer unit is generally provided to transfer the lubricant oil in an efficient and reliable manner from a static frame to the carrier. Such oil transfer units are generally known as “oil transfer bearings” or as “rotary unions”. In particular, the unit supplies oil under pressure into an annular chamber defined by a sleeve which is fixed to the carrier. From such annular chamber, the pressurized oil flows towards the components requiring lubrication.

U.S. Pat. No. 8,813,469 B2, which corresponds to the preamble of claim 1, discloses an oil transfer unit having a bearing which has an annular channel, in which lubricant flows, and is mounted onto an outer cylindrical surface of the sleeve without contact sealing rings.

The outer cylindrical surface of the sleeve has a radial passage arranged at the same axial position of the annular channel so as to put such channel into communication with the inner annular chamber. A minimum radial gap is provided between the inner cylindrical surfaces of the bearing and the outer cylindrical surface of the sleeve, to allow rotation of the sleeve and, in the meantime, to define a seal.

The amount of such radial gap is accurately determined in the design stage, so as to minimize leakages and therefore maximize the volumetric efficiency for the transfer of the oil. In the meantime, the mating cylindrical surfaces of the bearing and the sleeve have to be machined with a high precision level, to ensure the radial gap that has been defined at the design stage.

This kind of solution avoids the arrangement of contact bearings and contact sealing rings between the cylindrical surfaces of the bearing and the sleeve.

In U.S. Pat. No. 8,813,469 B2 the sleeve directly projects from a circular body that is part of the planet carrier and holds the planet gears of the epicyclic transmission.

This kind of connection of the sleeve is rather unsatisfactory, because the actual position and shape of the outer cylindrical surface of the sleeve and the actual position of its rotation axis depend upon possible deformations of the planet carrier and alter the configuration that has been set during the design stage. These deformations and/or displacements may occur either in static conditions, e.g. because of manufacturing tolerances, assembly tolerances and/or static loads, or during the operating dynamic conditions.

Indeed, when the planet carrier rotates during the operating conditions, such deformations can cause relevant relative movements between the fixed oil source at the static frame and the outer cylindrical surface of the sleeve where the oil has to be supplied to reach the components to be lubricated, supported by the carrier.

It is the object of the present invention to obtain an assembly provided with a rotating supporting member and with an oil transfer unit for transferring oil from a stationary part to such rotating supporting member, which allows to solve the above mentioned drawbacks in a simple and cost-effective manner.

According to the present invention there is provided an assembly comprising a supporting member rotatable about an axis and an oil transfer unit for transferring oil to said supporting member. The unit comprising at least one or more of a stationary part comprising an oil mouth; a rotating part coupled in an angularly fixed position to said supporting member and having one or more of (a) an inner chamber permanently communicating with said oil mouth, and (b) an outer cylindrical surface extending along said axis; a floating part fitted onto said outer cylindrical surface and coupled to said stationary part in an angularly fixed position about said axis and with a defined freedom of movement; characterized by comprising a connection member coaxial to said rotating part and said supporting element and comprising one or more of at least one first portion fixed to said rotating part, at least one second portion fixed to said supporting element, at least one intermediate portion, which is arranged between said first and second portions and is elastically flexible.

The intermediate portion may have a plate-shaped cross-section. The intermediate portion may comprise a circular portion coaxial to, and fitted around, an outer element of said rotating part.

The circular portion may comprise at least one curved section having a concavity that axially faces. The circular portion may further comprise a cylindrical section, and a conical section. The curved section may join the cylindrical and conical sections to each other. The thickness of the conical section may be greater than the one of said cylindrical section.

The intermediate portion may comprise a plurality of sectors, which are angularly spaced apart from each other about the axis. The sectors may outwardly end at said second portion. The second portion may be defined by a plurality of lugs; each sector may be provided with two said lugs, which are angularly spaced apart along an outer arc edge of the sector. Each sector may comprise a main portion; and the edge may have a greater thickness than the main portion.

The sectors may have respective apertures. The supporting element may be defined by a planet carrier of an epicyclic transmission.

### BRIEF DESCRIPTION OF THE DRAWINGS

The present invention will now be described with reference to the accompanying drawings, which show a non-limiting embodiment thereof, in which:

FIG. 1 is a diagram corresponding to a partial cross-section of a turbine engine, which includes a preferred embodiment of the assembly provided with a rotating supporting member and with an oil transfer unit for transferring oil to such rotating supporting member, according to the present invention;

FIG. 2 is a front view of the assembly in FIG. 1;

FIGS. 3 and 4 are a front and a rear perspective view showing details of the assembly in FIG. 2, in an enlarged scale and with elements removed for sake of clarity;

FIG. 5 is a perspective view showing, in an enlarged scale and with elements removed for sake of clarity, the oil transfer unit of the assembly;

FIG. 6 is an enlargement of a detail of FIG. 2, with elements removed for sake of clarity; and

FIGS. 7 and 8 are cross-sections, in enlarged scales, according to the sectional plane VIII-VIII in FIG. 2 and showing the detail of FIGS. 3 and 4 and, respectively, the oil transfer unit.

### DETAILED DESCRIPTION

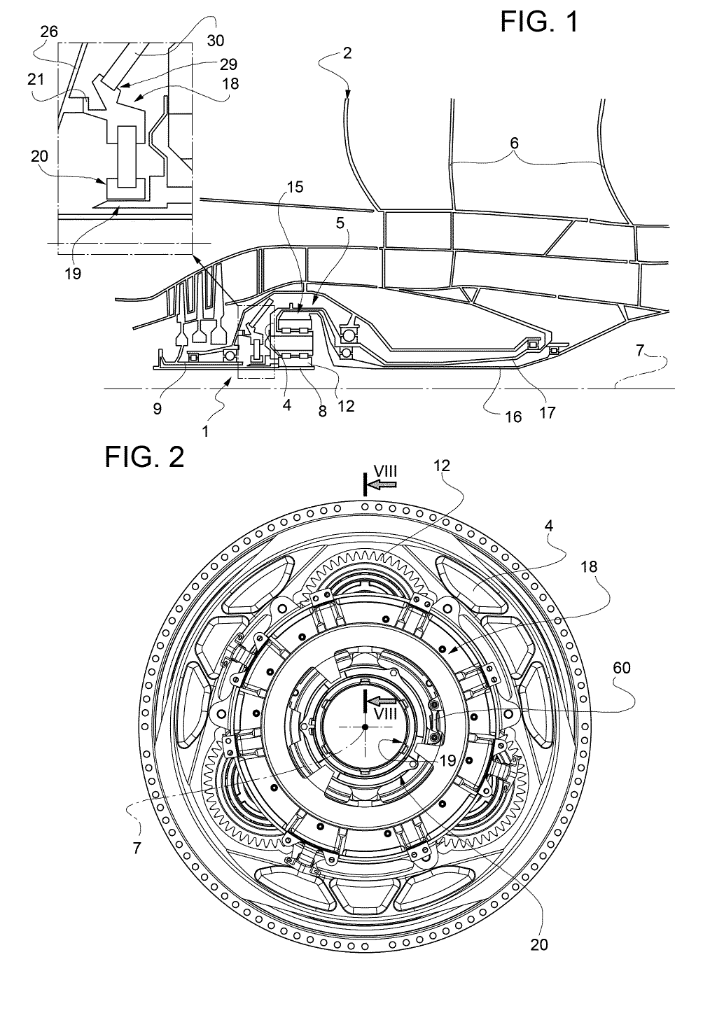

With reference to the diagram of FIG. 1, reference numeral 1 indicates an oil transfer unit for transferring oil between a stationary part and a rotating part. In this specific and preferred embodiment, unit 1 is mounted in a turbine engine 2 (partially and diagrammatically shown) and is used to supply lubricating oil towards a rotating planet carrier 4 defining part of an epicyclic transmission 5. In particular, the engine 2 shown in FIG. 1 is of the kind commonly known as “open rotor” and comprises two propellers 6 rotating in opposite directions about an axis 7.

Transmission 5 comprises a sun gear 8, which is rotational about axis 7 and is connected to an input shaft 9 so as to be driven by a turbine; a plurality of planet gears 12, which mesh with the sun gear 8, are supported by the carrier 4 and are rotational about respective axes, parallel and eccentric with respect to axis 7; and a ring gear 15, coaxial with the sun gear 8 and meshing with the planet gears 12 on the outer side.

Ring gear 15 and carrier 4 are connected in an angularly fixed manner to respective output members 16 and 17, which are coaxial with shaft 9 and drive corresponding propellers 6.

The particular differential configuration that has just been described for the epicyclic transmission 5 and the particular open rotor configuration that has been indicated for the engine 2 do not exclude the use of unit 1 according to the present invention for other kinds of epicyclic transmissions and/or engines, or for other kind of devices that need an oil supply. By way of example, unit 1 can be used to supply oil to rotating hydraulic actuators or systems, in particular to actuators controlled to adjust the pitch angle of the propeller blades (commonly known as PCM, i.e. pitch control mechanisms).

With reference to the diagrammatic enlarged view shown in FIG. 1, unit 1 comprises a stationary part 18, fixed with respect to a supporting structure of the engine 2; a rotating part 19, coaxial and angularly fixed with respect to the carrier 4; and a non-rotating floating part 20 which is configured so as to transfer oil from part 18 to part 19 and to have a certain degree of freedom in its movements with respect to part 18, as it will be described below in more detail.

As far as the support of part 18 is concerned, the latter is directly fixed to a so-called mid static frame 26, supporting the shaft 9 and the output members 16 and 17 by means of rolling bearings. In particular, part 18 comprises one or more flanges 21 bolted to frame 26.

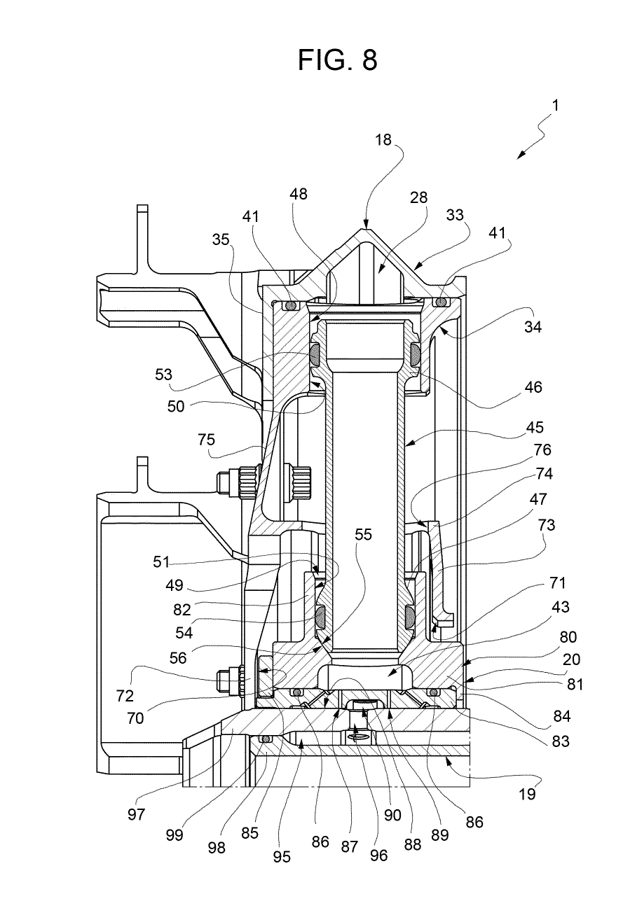

Part 18 has an inner annular channel 28 (FIG. 8) and one or more inlet mouths 29, which receive pressurized oil from a hydraulic system 30 of the engine 2 and permanently communicate with channel 28 for supplying oil into such channel 28.

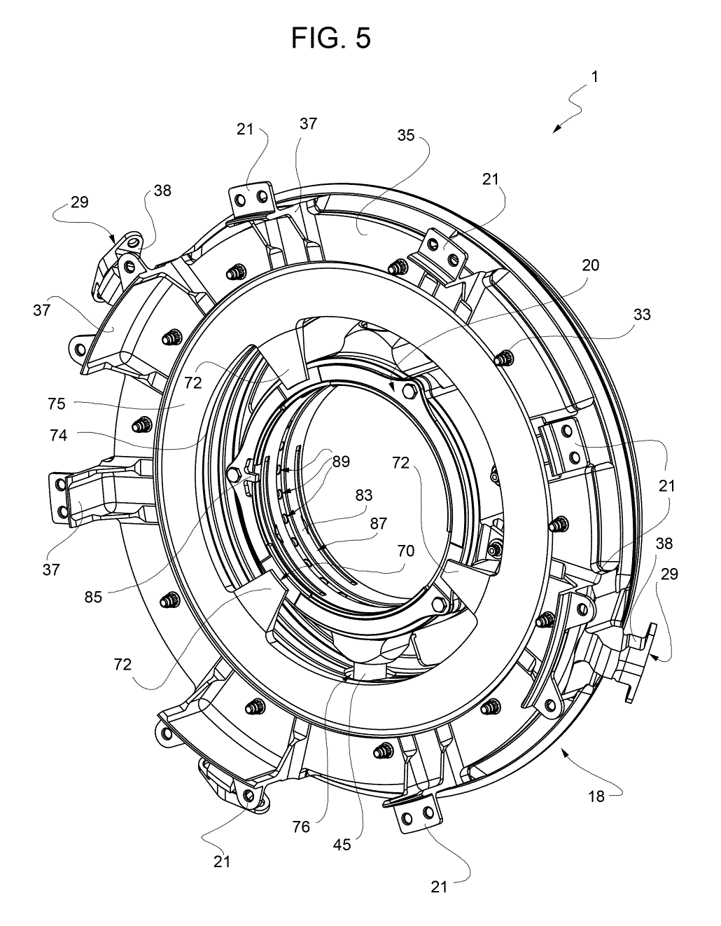

With reference to FIG. 8, part 18 comprises two annular elements 33 and 34, which are fixed to each other and are arranged respectively in a outer position and in an inner position with respect to axis 7. In particular, elements 33,34 comprise respective flanges, that are transversal to axis 7, axially rest against each other and are bolted to each other—the flange of element 33 is indicated by reference number 35 in FIGS. 5 and 8. As shown in FIG. 5, flanges 21 define parts of respective projections 37, that protrude from flange 35 and are made in one piece with element 33. Besides, in particular, inlet mouths 29 are also defined by projections 38, that radially and outwardly protrude from element 33 and are made in one piece with element 33.

As shown in FIG. 8, elements 33 and 34 are coupled to each other by means of sealing rings 41, that are arranged on opposite axial sides of channel 28 to ensure fluid-tightness. Anyway, other kinds of construction (not shown) could be provided to define part 18. By way of example, part 18 could be manufactured in one piece by means of additive manufacturing techniques.

Channel 28 permanently communicates with an annular channel 43 of part 20 via one or more oil transfer tubes 45, each radially ending with two opposite heads 46,47. Head 46 is coupled in a fluid-tight manner to element 34, while head 47 is coupled in a fluid-tight manner to part 20. Heads 46 and 47 engage respective cylindrical seats 48 and 49 having respective cylindrical surfaces 50 and 51.

Unit 1 comprises only two tubes 45, arranged in diametrical opposite positions with respect to axis 7.

With reference again to FIG. 8, the outer side surfaces of heads 46 and 47 are coupled to the inner surfaces 50 and 51 by means of respective sealing rings 53,54 and in such a manner to give freedom for the tube 45 to slide along the axes of the seats 48,49. In addition, the outer side surfaces of heads 46 and 47 have respective diameters that are lower than the inner diameters of surfaces 50 and 51, so as to leave an annular gap between the heads 46,47 and the surfaces 50 and 51, in radial direction with respect to the axes of seats 48 and 49. Such gaps are closed by the sealing rings 53,54 and allow the tube 45 for a certain degree of freedom in rotation about a tangential direction with respect to parts 18 and 20.

The freedom of movements given to the tubes 45 allows the part 20 to float with respect to part 18, but does not compromise the sealing at the seats 48 and 49, as the sealing rings 53 and 54 elastically deform during such movements and continue to be in contact with surfaces 50,51.

According to a preferred aspect of unit 1, the diameter of surface 50 is different from, higher than, the diameter of surface 51. Thanks to the oil pressure in the channels 28 and 43 and in the tubes 45, this difference in diameter generates a thrust on the tubes 45 towards part 20 and axis 7. In the meantime, seat 49 has a surface 55, joined to surface 51 and defining a stop shoulder for an end surface 56 of the head 47, which therefore permanently rests onto surface 55. The shapes of surfaces 55 and 56 are designed so as to define a contact at a circular theoretical line, for allowing rotation for the head 47 about the tangential direction with respect to part 20. By way of example, surface 55 is shaped as conical, and surface 56 is shaped as a spherical surface having a center that is arranged on the axis of tube 45. Along the axis of the tube 45, such center is arranged at the mid-plane of the sealing ring 54, in order to minimize the reaction moment, generated by the elastic deformation of the seal, in presence of a misalignment of the tube 45 with respect to the floating part 20.

Sealing rings 53 and 54 define respective so-called dynamic seals, which are designed so as to avoid leakage from tubes 45 when there is a strong misalignment and to have high resistance with respect to the continuous sliding on the inner surface of the tubes 45 in dynamic conditions.

The shape of the outer profile in cross-section of the sealing rings 53 and 54 is trapezoidal or a D-shape, so as to avoid rubber seal spiral mode failures and rubber extrusion during the relative motion. Secondary, the above shape helps in obtaining an easier rotation of the heads 46,47.

As shown in FIGS. 2 and 6, rotation of part 20 about axis 7 is prevented by a connecting rod 60 having a rectilinear axis which extends in a tangential direction with respect to axis 7 when part 20 is arranged in a design reference position with respect to part 18.

The axis of the connecting rod 60 is arranged parallel to the tubes 45. This orientation allows to minimize the amplitude of the sliding and rotation movements of the heads 46,47 in the respective seats 48,49, for a given floating movement of part 20, so as to minimize the displacement and misalignment of the tubes 45 and, therefore, to minimize the risk of extrusion of the rubber seals (53 and 54).

The connecting rod 60 can be made of different pieces, fixed to each other, or can be made as a single piece. The connecting rod 60 has two opposite ends 61, which are connected to part 18 and 20 by respective spherical joints 63. The provision of a spherical joint 63 at each end of the connecting rod 60 ensures a degree of freedom in axial translation for the part 20, with respect to axis 7, and not only a degree of freedom in rotation.

As an aspect of the present invention, with reference to FIG. 5, the floating movement of part 20 is limited under a given range, established during the design stage, by the provision of shoulders 70,71 which are fixed with respect to part 18, are arranged on opposite axial sides of part 20 and axially face part 20. Shoulder 71 also radially faces part 20 (as it can be seen in FIG. 8).

Shoulders 70,71 are defined by respective series of tabs 72 and 73, which are spaced apart from each other about axis 7. The angular positions of the tabs 72 are staggered with respect to the angular positions of the tabs 73 about axis 7.

Tabs 72 and 73 project radially inward from opposite edges of a tubular ring 74, defining part of element 34. One of such edges is joined to the outer flange of element 34 by an intermediate annular wall 75, in order to support the tabs 72,73. For each tube 45, the ring 74 has a corresponding radial passage 76 engaged by such tube 45.

When part 20 is arranged in the design reference position with respect to part 18, an axial gap and a radial gap are provided between the shoulders 70,71 and the part 20, so as to allow the desired floating movements established during the design stage and, therefore, to ensure the optimal operating condition of the unit 1. During assembly of unit 1, on the other hand, shoulders 70,71 can come into contact with part 20, radially and/or axially, so as to limit the relative movements between parts 18 and 20. In this way, the assembly of the unit parts and the mounting of unit 1 in the engine 2 are easier and safer, without risk of damages.

According to what shown as a preferred embodiment in FIG. 8, part 20 comprises a main body 80, which in turn comprises an annular portion 81 defining the outer surface of channel 43; and, for each tube 45, a corresponding outer radial projection 82 defining seat 49. In particular, each of the projections 82 axially faces a corresponding tab 73.

Part 20 further comprises a bushing or annular pad 83, defined by a piece distinct and fixed with respect to body 80. In particular, pad 83 is axially sandwiched between a radial projection 84 of body 80 and a retaining ring 85, which axially rests onto, and is fixed to, body 80 on the opposite axial side of projection 84.

Pad 83 defines an inner surface of channel 43 and is coupled to body 80 by means of sealing rings 86 arranged on opposite axial sides of channel 43 to ensure fluid-tightness.

Pad 83 has a cylindrical surfaces 87 which directly faces and is fitted onto an outer cylindrical surface 88 of part 19 with a radial gap in a non-contact configuration, i.e. without any additional contact sealing element and any contact bearing therebetween. Pad 83 has one or more radial holes 89, putting channel 43 permanently into communication with an annular groove 90, which is delimited outwardly by the pad 83 and inwardly by the part 19 and axially splits surface 87 and/or surface 88 into two separated zones.

The size of the radial gap between surfaces 87,88 is defined during the design stage so as to allow rotation of part 19 and, in the meantime, define a hydrostatic seal with an oil film on each side of the groove 90 between surfaces 87,88 (i.e. at each of the two separated zones of the surfaces 87,88). Surfaces 87,88 have to be machined with a high level of precision and low tolerances in order to ensure both the rotation and the sealing conditions that have been defined during the design stage.

Part 19 has an inner annular chamber 95 and one or more radial holes 96, which are arranged at the same axial position of the groove 90 and put chamber 95 permanently into communication with the groove 90. Chamber 95, in turn, permanently communicates with one or more outlets (not shown) to supply oil to such outlets and, therefore, lubricate the gear meshes and/or the planet bearings.

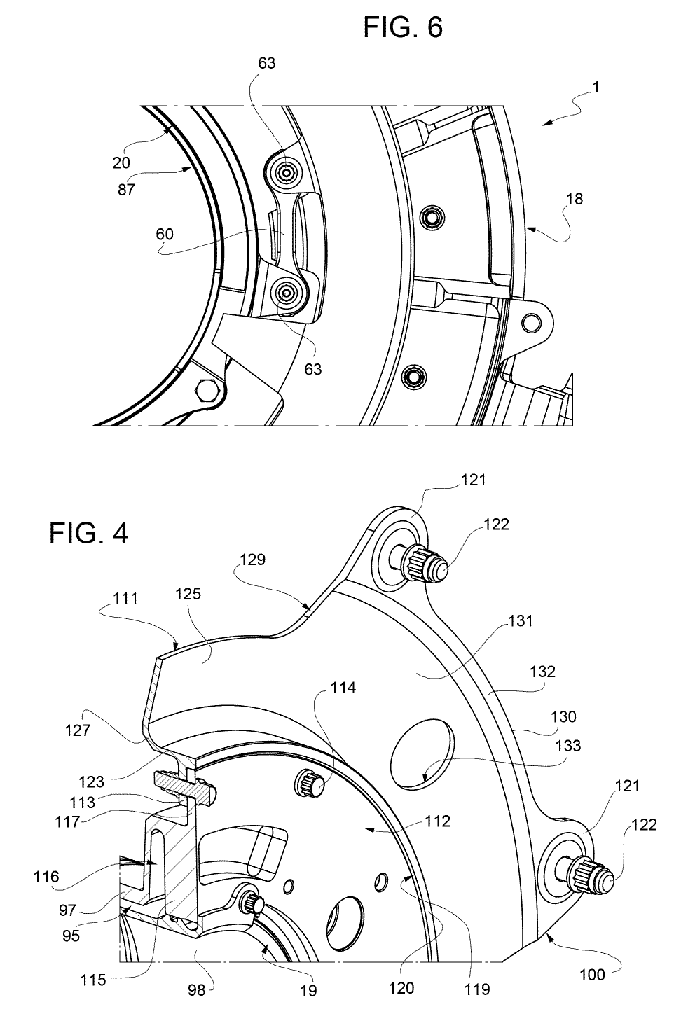

In particular, chamber 95 is defined by an outer sleeve 97 and an inner sleeve 98, which are coupled to each other by means of sealing rings 99 (FIG. 8) to ensure fluid-tightness. By way of example, sleeves 97,98 are fixed to each other by screws (FIG. 4).

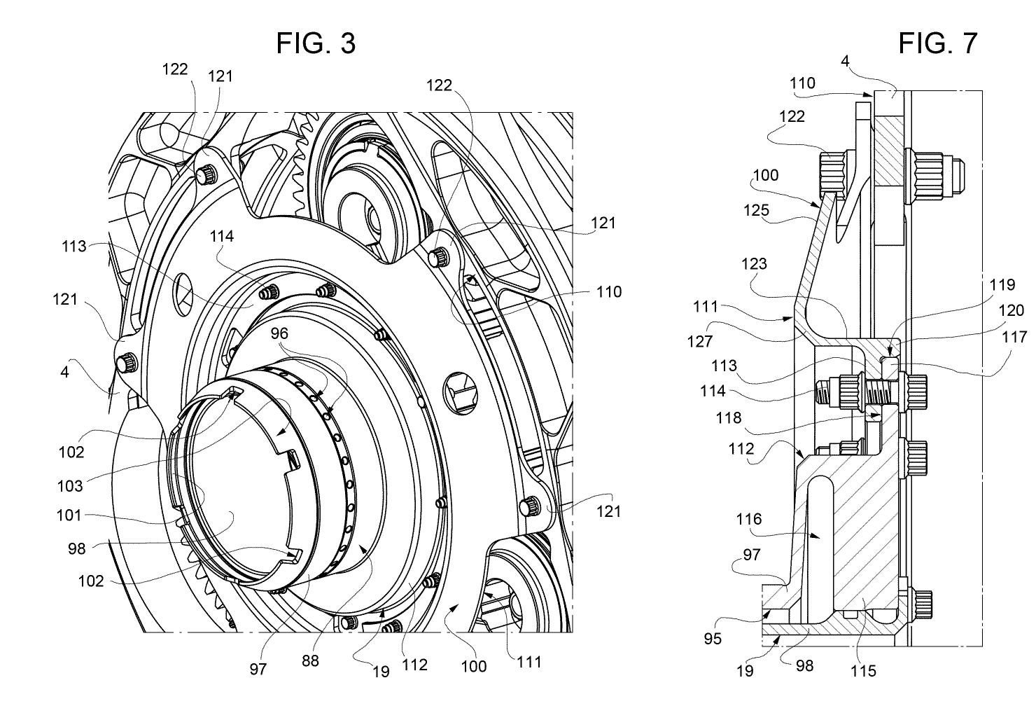

As shown in FIGS. 3 and 4, part 19 is coupled to the carrier 4 in an angularly fixed position by a disk member 100. Member 100 is coaxial to part 19 and carrier 4 and is fixed to sleeve 97, at one end, and to a front surface 110 of carrier 4, at the opposite end. Member 100 is defined by a single piece, and not by pieces fixed to each other. As an alternative, it may be manufactured by welding separate pieces.

In particular, member 100 comprises a circular portion 111 coaxial to, and fitted around, a ring element 112 integral with the sleeve 97; and one or more flanges 113, which project from circular portion 111, rest onto element 112 and are fixed to the latter, by screws or bolts 114.

More particularly, as shown in FIG. 7, element 112 comprises an inner portion 115, defining a outwardly radial branch 116 of the chamber 95; and an outer flange 117, which radially projects from portion 115 and defines a shoulder 118, on which flange 113 axially rests. Outwardly, flange 117 has a shoulder edge 119, which radially faces an axial projection 120 of member 100, so as to define a centering reference to fit circular portion 111 onto flange 117 in coaxial position.

With reference to FIG. 3, member 100 outwardly ends with a plurality of lugs or tongues 121, which rest onto surface 110 and are fixed to the carrier 4, in particular by screws or bolts 122.

According to a preferred aspect of the present invention, circular portion 111 has a plate-shaped cross-section, i.e. is defined by a wall having a relatively low thickness.

In particular, the cross-section of the circular portion 111 is constant along the whole circumference. However, according to variants that are not shown, an appropriate thickness variation may be provided along such circumference.

With reference to FIG. 4, circular portion 111 comprises a cylindrical section 123, which projects from an outer edge of the flanges 113. Section 123 axially projects in opposite direction with respect to the projection 120. Circular portion 111 further comprises a conical section 125, extending outwardly with an acute angle with respect to section 123; and a curved section 127, which joins sections 123,125 to each other and has a concavity that faces in a direction parallel to axis 7.

The thickness of section 125 is greater than the one of section 123. In particular, the thickness of section 127 progressively, i.e. without discrete steps, decreases from section 125 to section 123.

In general, the shape and thickness are optimized during the design stage to obtain the best behavior of the unit 1 in dynamic conditions. By way of example, the inclination of the conical section 125 and the length of the cylindrical section 123 can be different from what shown, as a function of specific dynamic conditions evaluated at the design stage.

According to another preferred aspect of the present invention, member 100 comprises a plurality of sectors 129, in particular three sectors 129, which join an outer edge of the circular portion 111 to the lugs 121, are angularly spaced apart from each other about axis 7 and have a plate-shaped cross-section, i.e. they are defined by respective walls having a relatively low thickness.

In particular, the sectors 129 outwardly extend as prolongations of the section 125, at the same angle and with the same thickness.

Each sector 129 is provided with two lugs 121, which are angularly spaced apart along an outer arc edge 130 of the sector 129.

Each sector 129 comprises a main portion 131 having a constant thickness that is equal to the one of the section 127 and lower than the one of the lugs 121. Each sector 129 further comprises an outer portion 132, defining the edge 130 and having a greater thickness, so as to join portion 131 to the lugs 121 and to locally stiffen the sectors 129.

The low thickness of some portions of the member 100 allows for a very low flexural rigidity. The flexural rigidity is particularly low at the areas in which the member 100 is fixed to the carrier 4, also because the sectors 129 are separated from each other by gaps (FIG. 3) along the circumferential direction.

In particular, the sectors 129 can elastically twist, so as to allow for axial relative displacements of the lugs 121.

Besides, portion 123 can elastically and radially deflect, thanks to its thin wall.

The combination of axial and radial flexibility is tuned during the design stage, to allow for a proper insulation of the sleeve 97 from the deflections of the carrier 4 and to optimize the dynamic behavior of the entire system. In other words, the deformations of the carrier 4 under load have a negligible influence on the actual position of the surface 88 during the operating conditions.

In particular, thanks to the curved shape of the section 127, both axial and radial deflections are managed with limited stress of the component.

As mentioned above, thanks to the low flexural rigidity, the position of the sleeve 97 has a low sensitivity in relation to possible deformations of the carrier 4 and/or to manufacturing and/or assembly tolerances of the carrier 4.

In the meantime, the design of the member 100 allows for the transfer of the torque to rigidly rotate the part 19 together with the carrier 4.

The meaning of the phrase “low thickness”, applied above for the sectors 129 and/or for the sections 123,125,127, is to be intended as a function of the size of the carrier 4 and/or the size of the member 100, and as a function of the specific application of the transmission 5. In particular, the thickness is sufficiently low if the ratio between:

the radial distance between flanges 113 and lugs 121 and

the thickness of portions 131 and/or sections 123 and/or sections 125 is greater than 25.

By way of example, the above mentioned thickness is less than 4 mm (typically a thickness of 2-3 mm).

The flexural rigidity of the member 100 is locally reduced by providing apertures 133 through the sectors 129 and/or through the section 127, at appropriate positions and with appropriate sizes that are established during the design stage. By way of example, for each sector 129, a single aperture 133 is provided in an angular position that is symmetric with respect to the angular positions of the corresponding lugs 121, so that portion 131 is substantially split in two zones.

With reference to FIG. 3, on the axial side opposite to member 100, part 19 ends with a front portion 101 having a plurality of axial notches 102, which start from the edge of portion 101, are angularly spaced along such edge and have the function of draining possible oil that could be trapped because of centrifugal forces.

Portion 101 is outwardly defined by a bevel or chamfer 103 joined to surface 88 and tapered towards the above mentioned edge to perform a leading function when part 20 is fitted onto part 19 and, therefore, simplify the assembly operations of unit 1.

From the above, the advantages of the unit 1 claimed and described with reference to the accompanying drawings should be evident.

Indeed, as explained above in detail, the provision of at least one flexible intermediate portion in member 100 between lugs 121 and flanges 113 allows for insulating the part 19 from possible deflection of the carrier 4, in particular deflections occurring under load. In other words, the flexibility of member 100 compensates for possible movements of the surface 110 of the carrier 4, so as to allow for obtaining optimal operating conditions and, therefore, a lower wear at the radial gap between the surfaces 87,88. This outcome means that oil leakage is relatively low at the interface between surfaces 87 and 88 and, furthermore, that unit 1 has a longer life time and/or can be used at higher rotational speeds.

The amount of relative movement compensation is relatively high, also thanks to the particular design features (size, shape, configuration, etc.) of the various zones of the member 100. In addition, the member 100 is rather compact and lightweight.

Furthermore, no additional contact sealing elements are used at the interface between surfaces 87, 88 so that friction, consequent wear and the overall number of components are reduced.

It is apparent from the above features and considerations that modifications or variants may be made to unit 1 without departing from the scope of protection as defined by the appended claims.

In particular, member 100 could be fixed to carrier 4 and/or to part 19 in a different way, with respect to the flanges 113 and the lugs 121 and to the bolts 114,122.

Shape and size of the portion 111 and/or the sectors 129 could even be different from what shown in the attached drawings as a preferred embodiment.

Furthermore, as mentioned above, unit 1 can be mounted to frame 26 and/or carrier 4 differently from what described above and/or can be used in applications different from epicyclic transmissions. In this latter case, member 100 is fixed to a rotating supporting element different from carrier 4. Perhaps, in other applications, such supporting member and part 19 can have a sliding movement in addition to the rotational one, with respect to part 18.

Furthermore, shape, number and/or configuration of the passages and conduits between the mouth 29 and the outlets could be different from what described with reference with the attached drawings. Finally, even a contact bearing system and/or a contact sealing system could be provided in unit 1, instead of the radial gap between the surfaces 87, 88.

It will be clear to the skilled person that modifications may be made to the above-described embodiment without departing from the invention as set out in the following claims.

What we claim is:

1. An assembly comprising a supporting member rotatable about an axis and an oil transfer unit for transferring oil to said supporting member; the unit comprising:
a stationary part comprising an oil mouth;
a rotating part coupled in an angularly fixed position to said supporting member and having:
a) an inner chamber permanently communicating with said oil mouth and
b) an outer cylindrical surface extending along said axis;
a floating part fitted onto said outer cylindrical surface and coupled to said stationary part in an angularly fixed position about said axis and with a defined freedom of movement;
further comprising a connection member coaxial to said rotating part and said supporting element and comprising:
at least one first portion fixed to said rotating part;
at least one second portion fixed to said supporting element;
at least one intermediate portion, which is arranged between said first and second portions and is elastically flexible.

2. The assembly according to claim 1, wherein said intermediate portion has a plate-shaped cross-section.

3. The assembly according to claim 2, wherein said intermediate portion comprises a circular portion coaxial to, and fitted around, an outer element of said rotating part.

4. The assembly according to claim 3, wherein said circular portion comprises at least one curved section having a concavity that axially faces.

5. The assembly according to claim 4, wherein said circular portion further comprises a cylindrical section, and a conical section; said curved section, joining said cylindrical and conical sections to each other.

6. The assembly according to claim 5, wherein the thickness of said conical section is greater than the one of said cylindrical section.

7. The assembly according to claim 2, wherein said intermediate portion comprises a plurality of sectors, which are angularly spaced apart from each other about said axis.

8. The assembly according to claim 7, wherein said sectors outwardly end at said second portion.

9. The assembly according to claim 8, wherein said second portion is defined by a plurality of lugs; each said sector being provided with two said lugs, which are angularly spaced apart along an outer arc edge of the sector.

10. The assembly according to claim 9, wherein each said sector comprises a main portion; said edge having a greater thickness than said main portion (131).

11. The assembly according to claim 7, wherein said sectors have respective apertures.

12. The assembly according to claim 1, wherein said supporting element is defined by a planet carrier of an epicyclic transmission.
